(19) United States
(12) Patent Application Publication
(10) Pub. No.: US 2024/0221229 A1
(43) Pub. Date: Jul. 4, 2024

(54) METHOD AND APPARATUS TO ENCODE MESH BASED ON SYMMETRY PROPERTY

(71) Applicant: TENCENT AMERICA LLC, Palo Alto, CA (US)

(72) Inventors: Thuong NGUYEN CANH, San Bruno, CA (US); Chao HUANG, Palo Alto, CA (US); Xiaozhong XU, Palo Alto, CA (US); Shan LIU, Palo Alto, CA (US)

(73) Assignee: TENCENT AMERICA LLC, Palo Alto, CA (US)

(21) Appl. No.: 18/464,724

(22) Filed: Sep. 11, 2023

Related U.S. Application Data
(60) Provisional application No. 63/436,827, filed on Jan. 3, 2023.

(51) Int. Cl. G06T 9/00; G06T 17/20

(52) U.S. Cl. CPC G06T 9/001; G06T 17/205

(57) ABSTRACT

A method performed by at least one processor of an encoder includes performing, on a mesh, decimation based on one or more symmetrical properties of the input mesh to generate a decimated mesh. The method includes performing UV reparameterization on the decimated mesh to generate a UV reparameterized mesh. The method includes performing symmetry geometry reparameterization on the UV reparameterized mesh based on one or more symmetrical properties of the of the UV reparameterized mesh to generate geometric information for encoding the input mesh. The method includes encoding the mesh based on the geometric information.

### CROSS-REFERENCE TO RELATED APPLICATION

This application claims priority from U.S. Provisional Application No. 63/436,827 filed on Jan. 1, 2023, the disclosure of which is incorporated herein by reference in its entirety.

### FIELD

This disclosure is directed to a set of advanced video coding technologies. More specifically, the present disclosure is directed to a method and apparatus to encode a mesh based on a symmetry property.

### BACKGROUND

VMesh is an ongoing MPEG standard to compress dynamic meshes. The current VMesh reference software compresses meshes based on decimated base meshes, displacements vectors and motion fields. The displacements are calculated by searching the closest point on the input mesh with respect to each vertex of the subdivided based mesh. To encode the displacement, displacement vectors are transformed into wavelet coefficients by a linear lifting scheme, and then the coefficients are quantized and coded by a video codec or arithmetic codec. This process also refines the base mesh to minimize the displacement. Texture transfer may be performed to match the texture with reparameterized geometry and UV as well as optimized texture for image compression.

Reflection symmetry is a popular characteristic of mesh coding, especially computer generated meshes. Symmetry was utilized to compress symmetry mesh. Vertices are divided into a left and right part of a symmetry plane. The left part is encoded by mesh coding while the right part is encoded by a symmetry prediction and displacement coding.

However, in encoding of base mesh with lossless compression, mesh compression exploits local characteristics without consideration of the global characteristic of mesh symmetry. Furthermore, 3D meshes are often not perfectly symmetric, but rather approximately symmetric, where only the surface is approximately symmetric.

### SUMMARY

According to one or more embodiments a method performed by at least one processor of an encoder comprises performing, on a mesh, decimation based on one or more symmetrical properties of the mesh to generate a decimated mesh. The method includes performing UV reparameterization on the decimated mesh to generate a UV reparameterized mesh. The method includes performing symmetry geometry reparameterization on the UV reparameterized mesh based on one or more symmetrical properties of the of the UV reparameterized mesh to generate geometric information for encoding the mesh. The method further includes encoding the mesh based on the geometric information.

According to one or more embodiments, an encoder comprises: at least one memory configured to store program code, and at least one processor configured to read the program code and operate as instructed by the program code. The program code comprises first decimation code configured to cause the at least one processor to perform, on a mesh, decimation based on one or more symmetrical properties of the mesh to generate a decimated mesh, UV reparameterization code configured to cause the at least one processor to perform UV reparameterization on the decimated mesh to generate a UV reparameterized mesh, symmetry geometry reparameterization code configured to cause the at least one processor to perform symmetry geometry reparameterization on the UV reparameterized mesh based on one or more symmetrical properties of the of the UV reparameterized mesh to generate geometric information for encoding the mesh, and encoding code configured to cause the at least one processor to encode the input mesh based on the geometric information.

According to one or more embodiments, a non-transitory computer readable medium having instructions stored therein, which when executed by a processor in an encoder cause the encoder to execute a method comprising performing, on a mesh, decimation based on one or more symmetrical properties of the input mesh to generate a decimated mesh. The method includes performing UV reparameterization on the decimated mesh to generate a UV reparameterized mesh. The method includes performing symmetry geometry reparameterization on the UV reparameterized mesh based on one or more symmetrical properties of the of the UV reparameterized mesh to generate geometric information for encoding the input mesh. The method further includes encoding the mesh based on the geometric information.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of a block diagram of a communication system, in accordance with embodiments of the present disclosure.

FIG. 2 is a schematic illustration of a block diagram of a streaming system, in accordance with embodiments of the present disclosure.

FIG. 3 is a schematic illustration of an example mesh encoder, in accordance with embodiments of the present disclosure.

FIG. 4 is a schematic illustration of an example mesh encoder, in accordance with embodiments of the present disclosure.

FIG. 5 is a schematic illustration of an example mesh decoder, in accordance with embodiments of the present disclosure.

FIG. 6 is a flowchart of an example process for performing mesh encoding, in accordance with embodiments of the present disclosure.

FIG. 7 is a flowchart of an example process for performing mesh decoding, in accordance with embodiments of the present disclosure.

FIG. 8 is a diagram of a computer system suitable for implementing the embodiments of the present disclosure, in accordance with embodiment of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

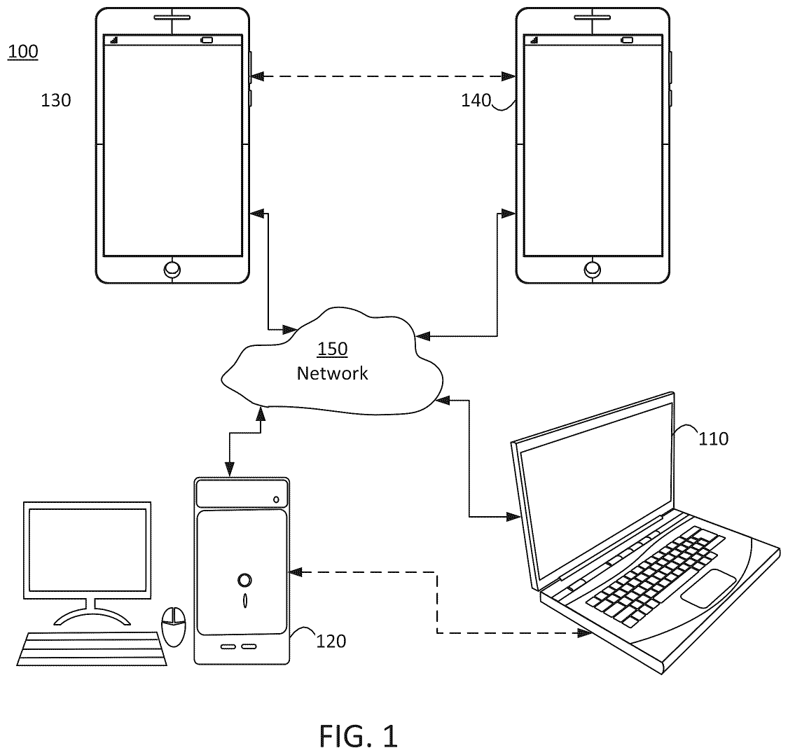

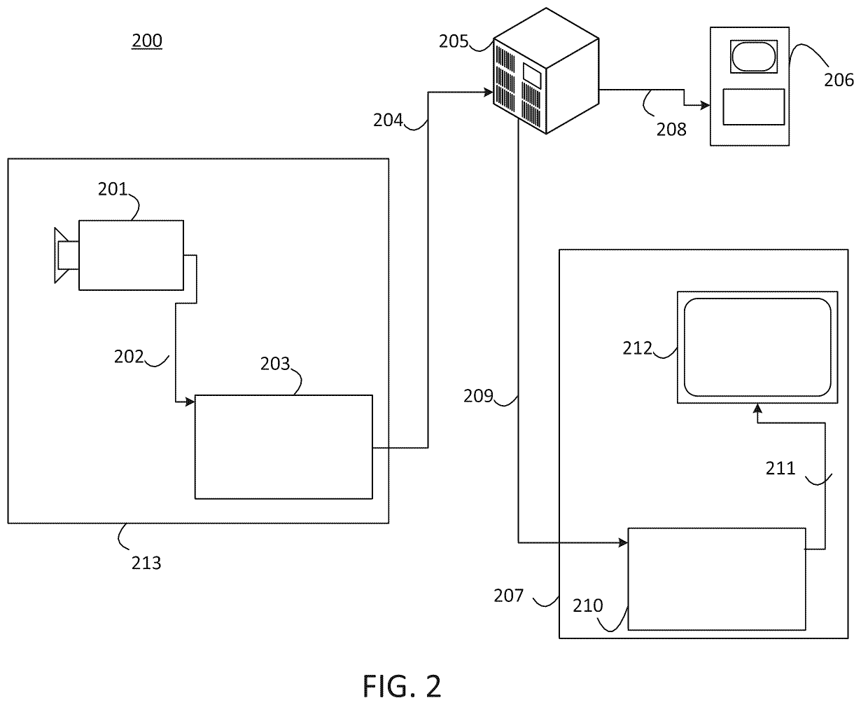

With reference to FIGS. 1-2, one or more embodiments of the present disclosure for implementing encoding and decoding structures of the present disclosure are described.

FIG. 1 illustrates a simplified block diagram of a communication system 100 according to an embodiment of the present disclosure. The system 100 may include at least two terminals 110, 120 interconnected via a network 150. For unidirectional transmission of data, a first terminal 110 may code video data, which may include mesh data, at a local location for transmission to the other terminal 120 via the network 150. The second terminal 120 may receive the coded video data of the other terminal from the network 150, decode the coded data and display the recovered video data. Unidirectional data transmission may be common in media serving applications and the like.

FIG. 1 illustrates a second pair of terminals 130, 140 provided to support bidirectional transmission of coded video that may occur, for example, during videoconferencing. For bidirectional transmission of data, each terminal 130, 140 may code video data captured at a local location for transmission to the other terminal via the network 150. Each terminal 130, 140 also may receive the coded video data transmitted by the other terminal, may decode the coded data and may display the recovered video data at a local display device.

In FIG. 1, the terminals 110-140 may be, for example, servers, personal computers, and smart phones, and/or any other type of terminals. For example, the terminals (110-140) may be laptop computers, tablet computers, media players and/or dedicated video conferencing equipment. The network 150 represents any number of networks that convey coded video data among the terminals 110-140 including, for example, wireline and/or wireless communication networks. The communication network 150 may exchange data in circuit-switched and/or packet-switched channels. Representative networks include telecommunications networks, local area networks, wide area networks, and/or the Internet. For the purposes of the present discussion, the architecture and topology of the network 150 may be immaterial to the operation of the present disclosure unless explained herein below.

FIG. 2 illustrates, as an example of an application for the disclosed subject matter, a placement of a video encoder and decoder in a streaming environment. The disclosed subject matter may be used with other video enabled applications, including, for example, video conferencing, digital TV, storing of compressed video on digital media including CD, DVD, memory stick and the like, and so on.

As illustrated in FIG. 2, a streaming system 200 may include a capture subsystem 213 that includes a video source 201 and an encoder 203. The streaming system 200 may further include at least one streaming server 205 and/or at least one streaming client 206.

The video source 201 may create, for example, a stream 202 that includes a 3D mesh and metadata associated with the 3D mesh. The video source 201 may include, for example, 3D sensors (e.g. depth sensors) or 3D imaging technology (e.g. digital camera(s)), and a computing device that is configured to generate the 3D mesh using the data received from the 3D sensors or the 3D imaging technology. The sample stream 202, which may have a high data volume when compared to encoded video bitstreams, may be processed by the encoder 203 coupled to the video source 201. The encoder 203 may include hardware, software, or a combination thereof to enable or implement aspects of the disclosed subject matter as described in more detail below. The encoder 203 may also generate an encoded video bitstream 204. The encoded video bitstream 204, which may have a lower data volume when compared to the uncompressed stream 202, may be stored on a streaming server 205 for future use. One or more streaming clients 206 and 207 may access the streaming server 205 to retrieve video bit streams 208 and 209, respectively that may be copies of the encoded video bitstream 204.

The streaming clients 207 may include a video decoder 210 and a display 212. The video decoder 210 may, for example, decode video bitstream 209, which is an incoming copy of the encoded video bitstream 204, and create an outgoing video sample stream 211 that may be rendered on the display 212 or another rendering device (not depicted). In some streaming systems, the video bitstreams 204, 208, and 209 may be encoded according to certain video coding/compression standards.

Embodiments of the present disclosure directed to of applying mesh symmetry to the video-based dynamic mesh coding (V-DMC) process for performing decimation and reparameterization before encoding a bitstream. A mirror symmetry plane is estimated in a symmetry estimation process, where half of the symmetry mesh is extracted. Decimation is performed on the extracted symmetry mesh, and symmetry prediction and displacement are performed on the decimated mesh. Symmetry geometry reparameterization is performed after symmetry displacement. Based on utilizing symmetry in the decimation and reparameterization process, the embodiments of the present disclosure result in a more compact mesh for encoding.

The proposed methods may be used separately or combined in any order and may be used for arbitrary polygon meshes. According to the embodiments of the present disclosure, a mesh is assumed to be fully or partially symmetry in geometry.

Table 1 below illustrates an example mesh instance of a parameter set for signaling a quantization parameter.

TABLE 1

| | |
|---|---|
| mesh_instance_parameter_set( ) { | |
| for (i = 0; i < num_dim; i++) { | |
| mips_min_bbox [i] /* ?i*/ | i(b0) |
| } | |
| mips_num_instances_minus1 /* K− 1 */ | u(b1) |
| mips_base_bithdepth_minus1 /* QP0b−1*/ | u(b2) |
| misp_dist_bitdepth[0] /* QP0d−QP0b*/ | |
| for (k = 1; j <= mips_num_instance_minus1; j++) { | |
| mips_base_bitdepth [k−1] /*QPkb−QPk−1b */ | u(b1) |
| mips_dist_bitdepth[k] /* QPkd−QPkb*/ | i(b3) |
| } | |
| } | |

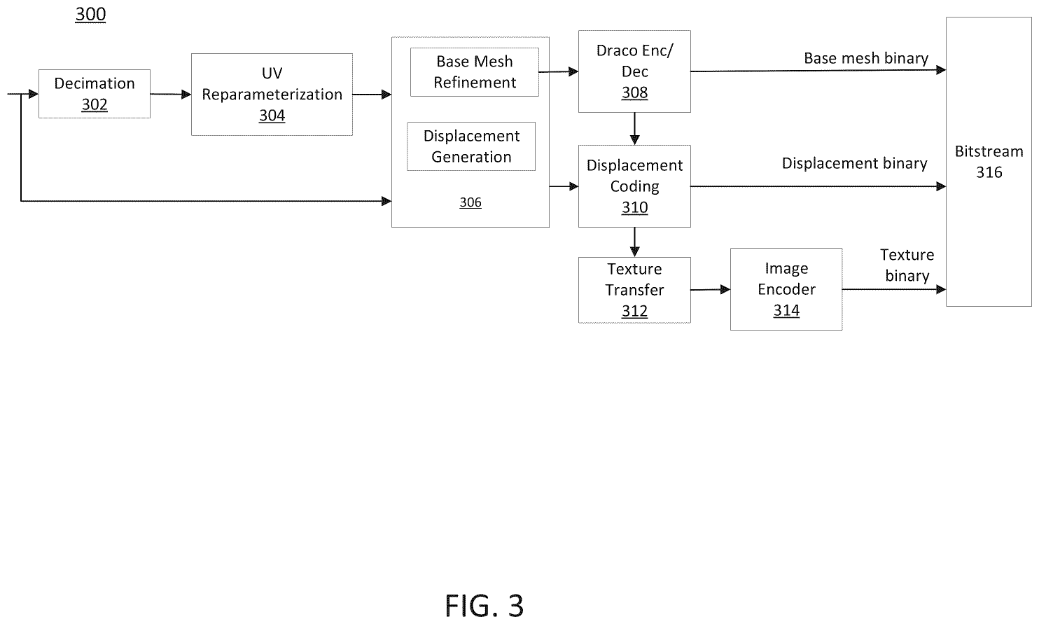

FIG. 3 illustrates an example mesh encoder 300. The encoder 300 may perform the V-DMC process for performing decimation and reparameterization before encoding a bitstream. As illustrated in FIG. 3, an input mesh may be subject to decimation 302 and UV reparameterization 304. Subsequently geometry reparameterization 306 is performed that includes base mesh refinement and displacement generation. The output of the base mesh refinement is provided to a Draco encoder 308 to generate a base mesh binary. The output of the displacement generation is provided to displacement coding 310 to generate displacement binary. The output of displacement coding 310 is provided to texture transfer 312 and image encoder 314 to generate texture binary. The base mesh binary, texture binary, and displacement binary may be included in bitstream 316. In one or more examples, texture coordinates or UV coordinates (often shortened to UVs) map the vertices to locations on the textures through a process called “UV Mapping”. The UVs define a 2D position in texture space for each vertex in the mesh.

According to one or more embodiments, a method to compress surface symmetry mesh [symbol] may be performed as follows. In one or more examples, a decimation process in Vmesh may be replaced with a symmetry decimation process with symmetry displacement coding, and geometry reparameterization is also updated to reflect the symmetry base mesh. As a result, significant bit savings are achieved by encoding only half of the base mesh.

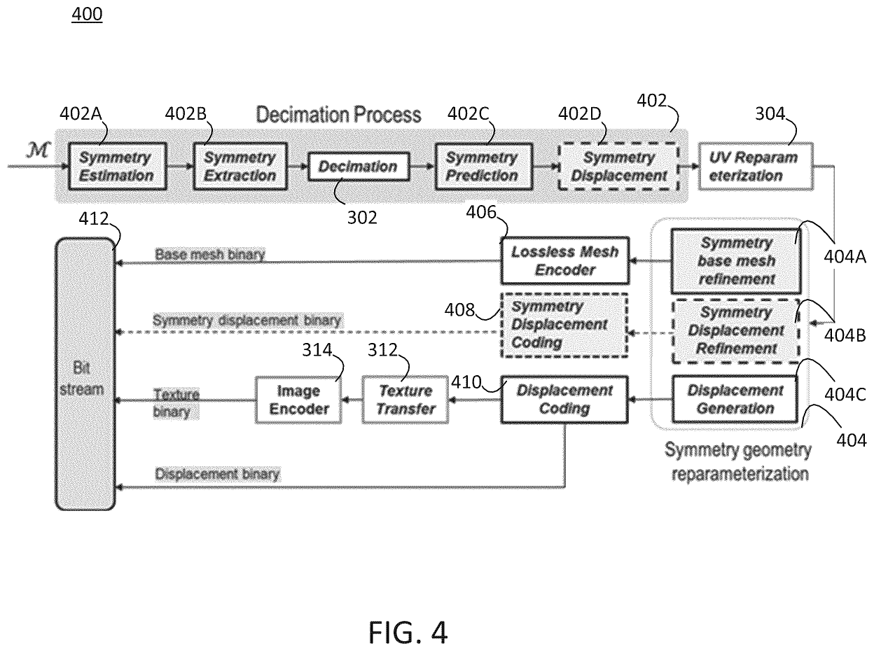

FIG. 4 illustrates an example mesh encoder that utilizes symmetry, in accordance with one or more embodiments. As illustrated in FIG. 4, a decimation process 402 utilizes symmetry properties or symmetrical properties of a mesh including partitioning a mesh in half via a symmetry plane and extracting one side of the partitioned mesh. The output of the decimation process 402 may be a decimated mesh.

In the decimation process 402, a mirror symmetry plane is estimated in a Symmetry Estimation process 402A, where the symmetry plane partitions a mesh into a first side (e.g., left side) and a second side (e.g., right side). Based on the symmetry plane, half of the symmetry mesh, with geometry information [symbol] (e.g., including left vertices [symbol] and associated connectivity [symbol] ), are extracted in a Symmetry Extraction process 402B.

Decimation 302 is performed to reduce the number of vertices while approximating a surface to generate a decimated geometry mesh [symbol] . A Symmetry Prediction process 402C is performed to predict the right geometry mesh [symbol] and connected with [symbol] to derive the geometry base mesh [symbol] . A Symmetry Displacement process 402D is performed to find the symmetry displacement [symbol] to compensate the symmetry prediction error to form the symmetry geometry base mesh to [symbol] ^{D}={ [symbol] }. In a UV reparameterization process 304, a base mesh is used re-parameterize texture coordinates (or UV attribute) as [symbol] , which contains a left [symbol] and a right UV [symbol] part. One example of UV reparameterization is UV atlas. The output of the UV reparameterization process 304 may be a UV reparameterized mesh.

According to one or more embodiments, a Symmetry geometry reparameterization process 404 is performed. The output of the Symmetry geometry process 404 may be geometric information for encoding the input mesh. The Symmetry geometry reparameterization process 404 may further fine tune the symmetry geometry base mesh [symbol] ^{D} in a Symmetry base mesh refinement process 404A and fine tune the symmetry displacement [symbol] _{S} in a Symmetry Displacement Refinement process 404B. The Symmetry base mesh refinement process 404A may fine tune the geometry base mesh [symbol] by reorganizing one or more parameters of the geometry base mesh that minimizes distortion or prediction error. The Symmetry Displacement Refinement process 404B may fine tune the symmetry displacement such that distortion or prediction error is minimized.

The output of the Symmetry base mesh refinement process 404A may be part of the geometric information for encoding the input mesh. The output of the Symmetry Displacement Refinement process 404B may be part of the geometric information for encoding the input mesh.

The displacement between symmetry base mesh [symbol] ^{D} and input mesh [symbol] may also be derived in the Symmetry geometry reparameterization process 404. The output of the Symmetry base mesh refinement process 404A may be provided to a lossless mesh encoder 406 where an adjusted half symmetry base mesh [symbol] and [symbol] is encoded to generate base mesh binary. In one example, Draco is used.

In one or more examples, the output of the Symmetry Displacement Refinement process 404B is provided to a Symmetry Displacement Coding process 408 to generate symmetry displacement binary.

In one or more examples, the Symmetry geometry reparameterization process 404 includes a Displacement Generation process 404C. The output of the Displacement Generation process is provided to a Displacement Coding process 410 to encode the surface displacement [symbol] ₛ and generate displacement binary. The Texture Transfer 312 and image encoder 314 are used to compress the associated texture images to generate texture binary.

The generated bitstream 412 may include the base mesh binary, symmetry displacement binary, texture binary, and the displacement binary. In one or more examples, associated symmetry information such as a symmetry plane is also signaled through the bitstream 412 as a part of header information.

According to one or more embodiments, Symmetry Displacement 402D, Symmetry Displacement Refinement 404B, and Symmetry Displacement Coding 408 are removed, where the distortion of symmetry prediction is handled by the general displacement coding 410.

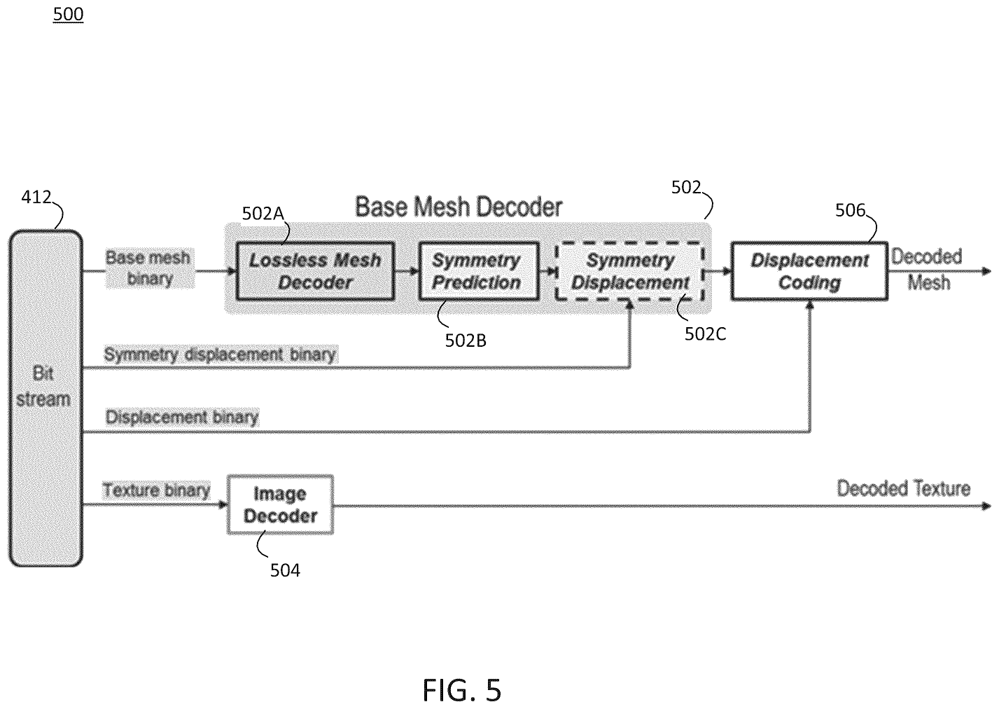

FIG. 5 illustrates an example decoder 500 decoding a mesh included in a bitstream, in accordance with one or more embodiments. In one or more examples, the decoder 500 performs a process to decode a symmetry-based mesh. The decoder 500 receives bitstream 412 as an input.

In one or more examples, the decoder 500 includes Base Mesh Decoder 502. Base mesh binary is decoded by the corresponding Lossless Mesh Decoder 502A. Together with symmetry information, a Symmetry Prediction process 502B is performed to output a reconstructed base mesh. A Symmetry Displacement coding process 502C may be performed with the symmetry displacement binary to deliver the reconstructed refined base mesh. Then, surface displacement coding 506 is applied with displacement binary to restore the compressed 3D mesh. In one or more examples, Image Decoder 504 is used to decode the texture binary to generate decode texture.

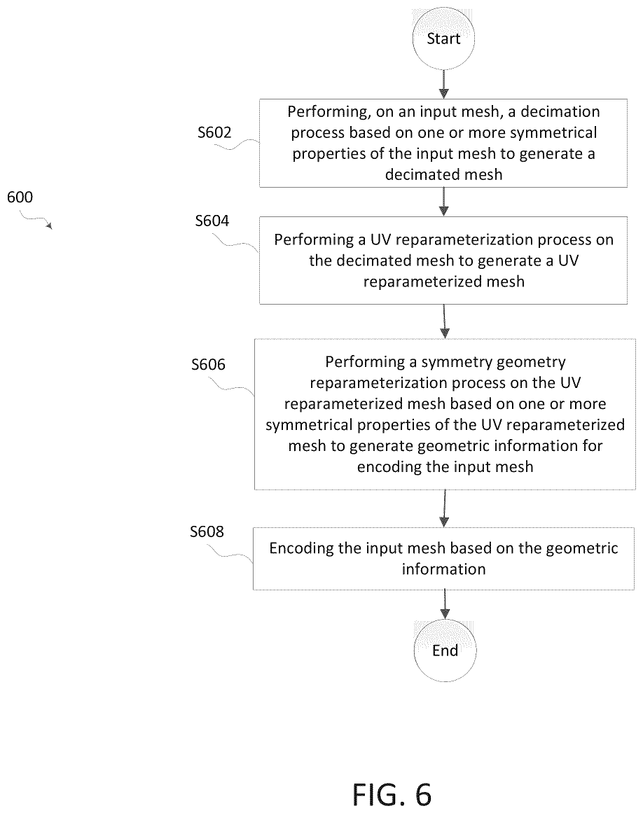

FIG. 6 illustrates a flow chart of an example encoding process 600, in accordance with one or more embodiments. The process 600 may be performed by encoder 400 in FIG. 4.

The process may start at S602 where a decimation process is performed on an input mesh based on one or more symmetrical properties of the input mesh to generate a decimate mesh. For example, referring to FIG. 4, the decimation process may correspond to decimation process 402 that includes Symmetry Estimation process 402A, Symmetry Extraction process 402B, Symmetry Prediction process 402C, and Symmetry Displacement process 402D.

The process proceeds to operation S604 where a UV reparameterization process is performed on the decimated mesh to generate a UV reparameterized mesh. For example, this operation may be performed by UV Reparameterization process 304.

The process proceeds to operation S606 where a symmetry reparameterization process is performed on the UV reparameterized mesh based on one or more symmetrical properties of the UV reparameterized mesh to generate geometric information for encoding the input mesh. For example, this operation may be performed by Symmetry geometry reparameterization operation 404 that includes Symmetry base mesh refinement process 404A and Symmetry Displacement Refinement process 404B. The process proceeds to operation S608 where the input mesh is encoded based on the geometric information.

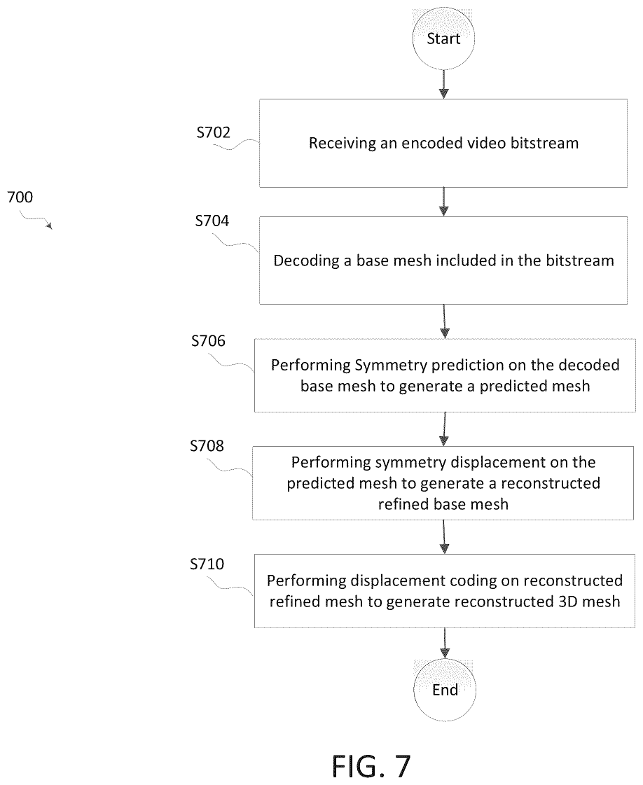

FIG. 7 illustrates a flow chart of an example decoding process 700, in accordance with one or more embodiments. The process 700 may be performed by decoder 500 in FIG. 5.

The process may start at operation S702 where an encoded video bitstream is received. The encoded video bitstream may correspond to the bitstream 412 generated in by the encoder 400 in FIG. 4.

The process proceeds to operation S704 where a base mesh included in the bitstream is decoded. For example, the base mesh may be decoded by the Lossless Mesh Decoder 502A in FIG. 5.

The process proceeds to operation S706 where symmetry prediction is performed on the decoded base mesh to generate a predicted mesh. For example, the Symmetry Prediction process 502B in FIG. 5 may be performed on the decoded base mesh to generate the predicted mesh.

The process proceeds to operation S708 where symmetry displacement is performed on the predicted mesh to generate a reconstructed refined base mesh. For example, the Symmetry Displacement process 502C in FIG. 4 may be performed on the predicted mesh to generate the reconstructed refined base mesh.

The process proceeds to operation S710 where displacement coding is performed on the reconstructed refined mesh to generate a reconstructed 3D mesh. For example, the Displacement Coding process 506 may be performed on the reconstructed refined mesh to generate the reconstructed 3D mesh.

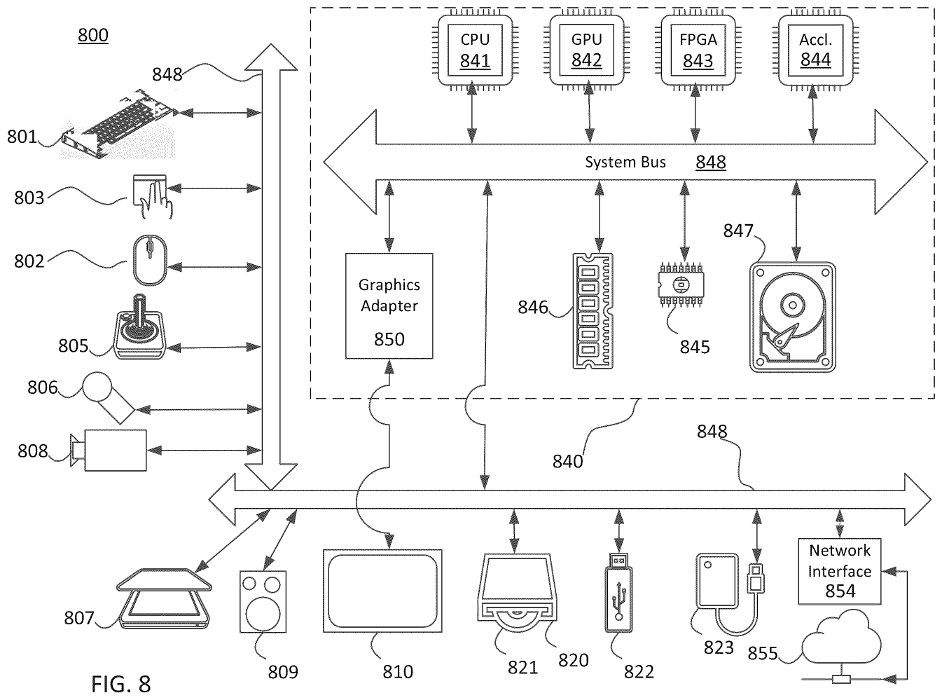

The techniques, described above, may be implemented as computer software using computer-readable instructions and physically stored in one or more computer-readable media. For example, FIG. 8 shows a computer system 800 suitable for implementing certain embodiments of the disclosure.

The computer software may be coded using any suitable machine code or computer language, that may be subject to assembly, compilation, linking, or like mechanisms to create code including instructions that may be executed directly, or through interpretation, micro-code execution, and the like, by computer central processing units (CPUs), Graphics Processing Units (GPUs), and the like.

The instructions may be executed on various types of computers or components thereof, including, for example, personal computers, tablet computers, servers, smartphones, gaming devices, internet of things devices, and the like.

The components shown in FIG. 8 for computer system 800 are examples and are not intended to suggest any limitation as to the scope of use or functionality of the computer software implementing embodiments of the present disclosure. Neither should the configuration of components be interpreted as having any dependency or requirement relating to any one or combination of components illustrated in the non-limiting embodiment of a computer system 800.

Computer system 800 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices may also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 801, mouse 802, trackpad 803, touch screen 810, data-glove, joystick 805, microphone 806, scanner 807, camera 808.

Computer system 800 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 810, data glove, or joystick 805, but there may also be tactile feedback devices that do not serve as input devices). For example, such devices may be audio output devices (such as: speakers 809, headphones (not depicted)), visual output devices (such as screens 810 to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system 800 may also include human accessible storage devices and their associated media such as optical media including CD/DVD ROM/RW 820 with CD/DVD or the like media 821, thumb-drive 822, removable hard drive or solid state drive 823, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 800 may also include interface to one or more communication networks. Networks may be wireless, wireline, optical. Networks may further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses 849 (such as, for example USB ports of the computer system 800; others are commonly integrated into the core of the computer system 800 by attachment to a system bus as described below (for example Ethernet interface into a PC computer system or cellular network interface into a smartphone computer system). Using any of these networks, computer system 800 may communicate with other entities. Such communication may be uni-directional, receive only (for example, broadcast TV), uni-directional send-only (for example CANbus to certain CANbus devices), or bi-directional, for example to other computer systems using local or wide area digital networks. Such communication may include communication to a cloud computing environment 855. Certain protocols and protocol stacks may be used on each of those networks and network interfaces as described above.

Aforementioned human interface devices, human-accessible storage devices, and network interfaces 854 may be attached to a core 840 of the computer system 800.

The core 840 may include one or more Central Processing Units (CPU) 841, Graphics Processing Units (GPU) 842, specialized programmable processing units in the form of Field Programmable Gate Areas (FPGA) 843, hardware accelerators for certain tasks 844, and so forth. These devices, along with Read-only memory (ROM) 845, Random-access memory 846, internal mass storage such as internal non-user accessible hard drives, SSDs, and the like 847, may be connected through a system bus 848. In some computer systems, the system bus 848 may be accessible in the form of one or more physical plugs to enable extensions by additional CPUs, GPU, and the like. The peripheral devices may be attached either directly to the core's system bus 848, or through a peripheral bus 849. Architectures for a peripheral bus include PCI, USB, and the like. A graphics adapter 850 may be included in the core 840.

CPUs 841, GPUs 842, FPGAs 843, and accelerators 844 may execute certain instructions that, in combination, may make up the aforementioned computer code. That computer code may be stored in ROM 845 or RAM 846. Transitional data may be also be stored in RAM 846, whereas permanent data may be stored for example, in the internal mass storage 847. Fast storage and retrieve to any of the memory devices may be enabled through the use of cache memory, that may be closely associated with one or more CPU 841, GPU 842, mass storage 847, ROM 845, RAM 846, and the like.

The computer readable media may have computer code thereon for performing various computer-implemented operations. The media and computer code may be those specially designed and constructed for the purposes of the present disclosure, or they may be of the kind well known and available to those having skill in the computer software arts.

As an example and not by way of limitation, the computer system having architecture 800, and specifically the core 840 may provide functionality as a result of processor(s) (including CPUs, GPUs, FPGA, accelerators, and the like) executing software embodied in one or more tangible, computer-readable media. Such computer-readable media may be media associated with user-accessible mass storage as introduced above, as well as certain storage of the core 840 that are of non-transitory nature, such as core-internal mass storage 847 or ROM 845. The software implementing various embodiments of the present disclosure may be stored in such devices and executed by core 840. A computer-readable medium may include one or more memory devices or chips, according to particular needs. The software may cause the core 840 and specifically the processors therein (including CPU, GPU, FPGA, and the like) to execute particular processes or particular parts of particular processes described herein, including defining data structures stored in RAM 846 and modifying such data structures according to the processes defined by the software. In addition or as an alternative, the computer system may provide functionality as a result of logic hardwired or otherwise embodied in a circuit (for example: accelerator 844), which may operate in place of or together with software to execute particular processes or particular parts of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

While this disclosure has described several non-limiting embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the embodiments listed below:

(1) A method performed by at least one processor of an encoder, the method comprising: performing, on a mesh, decimation based on one or more symmetrical properties of the mesh to generate a decimated mesh; performing UV reparameterization on the decimated mesh to generate a UV reparameterized mesh; performing a symmetry geometry reparameterization on the UV reparameterized mesh based on one or more symmetrical properties of the of the UV reparameterized mesh to generate geometric information for encoding the mesh; and encoding the mesh based on the generated geometric information.

(2) The method of feature (1), in which the performing the decimation further comprises: performing symmetry estimation on the mesh to estimate a mirror symmetry plane that partitions the mesh into a first side and a second side to generate a partitioned mesh; performing symmetry extraction on the partitioned mesh to extract the first side of the partitioned mesh; performing decimation on the first side of the mesh; and performing symmetry prediction after the decimation is performed to predict the second side of the partitioned mesh to generate the decimated mesh.

(3) The method of feature (2), in which the performing the decimation further comprises: performing, after the symmetry prediction is performed, symmetry displacement to compensate for symmetry prediction error generated by the symmetry prediction.

(4) The method of any one of features (1)-(3), in which the performing the symmetry geometry reparameterization on the UV reparameterized mesh further comprises: performing symmetry base mesh refinement on the UV reparameterized mesh based on the one or more symmetrical properties of the UV reparameterized mesh.

(5) The method of feature (4), in which an output of the symmetry base mesh refinement is provided to a lossless mesh encoder to generate base mesh binary information included in a bitstream.

(6) The method of any one of features (1)-(5), in which the performing the symmetry geometry reparameterization on the UV reparameterized mesh further comprises: performing symmetry displacement refinement on the UV reparameterized mesh based on the one or more symmetrical properties of the UV reparameterized mesh.

(7) The method of feature (6), further comprising: performing symmetry displacement coding on an output of the symmetry displacement refinement to generate symmetry displacement binary information included in a bitstream.

(8) An encoder comprising: at least one memory configured to store program code; and at least one processor configured to read the program code and operate as instructed by the program code, the program code comprising: first decimation code configured to cause the at least one processor to perform, on a mesh, a decimation process based on one or more symmetrical properties of the mesh to generate a decimated mesh, UV reparameterization code configured to cause the at least one processor to perform UV reparameterization on the decimated mesh to generate a UV reparameterized mesh, symmetry geometry reparameterization code configured to cause the at least one processor to perform symmetry geometry reparameterization on the UV reparameterized mesh based on one or more symmetrical properties of the of the UV reparameterized mesh to generate geometric information for encoding the mesh, and encoding code configured to cause the at least one processor to encode the mesh based on the generated geometric information.

(9) The encoder of feature (8), in which the first decimation code further comprises: symmetry estimation code configured to cause the at least one processor to perform symmetry estimation on the mesh to estimate a mirror symmetry plane that partitions the mesh into a first side and a second side to generate a partitioned mesh, symmetry extraction code configured to cause the at least one processor to perform symmetry extraction on the partitioned mesh to extract the first side of the partitioned mesh, second decimation code configured to cause the at least one processor to perform decimation on the first side of the mesh; and symmetry prediction code configured to cause the at least one processor to perform symmetry prediction after the decimation is performed to predict the second side of the partitioned mesh to generate the decimated mesh.

(10) The encoder of feature 9, in which first decimation code further comprises: symmetry displacement code configured to cause the at least one processor to perform, after the symmetry prediction is performed, symmetry displacement to compensate for symmetry prediction error generated by the symmetry prediction.

(11) The encoder of any one of features (8)-(10), in which the symmetry geometry reparameterization code further comprises: symmetry base mesh refinement code configured to cause the at least one processor to perform a symmetry base mesh refinement on the UV reparameterized mesh based on the one or more symmetrical properties of the UV reparameterized mesh.

(12) The encoder of feature (11), in which an output of the symmetry base mesh refinement is provided to a lossless mesh encoder to generate base mesh binary information included in a bitstream.

(13) The encoder of any one of features (8)-(12), in which symmetry geometry reparameterization code further comprises: symmetry displacement refinement code configured to cause the at least one processor to perform symmetry displacement refinement on the UV reparameterized mesh based on the one or more symmetrical properties of the UV reparameterized mesh.

(14) The encoder of feature (13), in which the program code further comprises: symmetry displacement code configured to cause the at least one processor to perform a symmetry displacement coding on an output of the symmetry displacement refinement to generate symmetry displacement binary information included in a bitstream.

(15) A non-transitory computer readable medium having instructions stored therein, which when executed by a processor in an encoder cause the encoder to execute a method comprising: performing, on a mesh, decimation based on one or more symmetrical properties of the mesh to generate a decimated mesh; performing UV reparameterization on the decimated mesh to generate a UV reparameterized mesh; performing a symmetry geometry reparameterization on the UV reparameterized mesh based on one or more symmetrical properties of the of the UV reparameterized mesh to generate geometric information for encoding the mesh; and encoding the mesh based on the generated geometric information.

(16) The non-transitory computer readable medium of feature (15), in which the performing the decimation further comprises: performing symmetry estimation on the mesh to estimate a mirror symmetry plane that partitions the mesh into a first side and a second side to generate a partitioned mesh; performing symmetry extraction on the partitioned mesh to extract the first side of the partitioned mesh; performing decimation on the first side of the mesh; and performing symmetry prediction after the decimation is performed to predict the second side of the partitioned mesh to generate the decimated mesh.

(17) The non-transitory computer readable medium of feature (16), in which the performing the decimation further comprises: performing, after the symmetry prediction is performed, symmetry displacement to compensate for symmetry prediction error generated by the symmetry prediction.

(18) The non-transitory computer readable medium of any one of features (15)-(17), in which the performing the symmetry geometry reparameterization on the UV reparameterized mesh further comprises: performing symmetry base mesh refinement on the UV reparameterized mesh based on the one or more symmetrical properties of the UV reparameterized mesh.

(19) The non-transitory computer readable medium of feature (18), in which an output of the symmetry base mesh refinement is provided to a lossless mesh encoder to generate base mesh binary information included in a bitstream.

(20) The non-transitory computer readable medium of any one of features (15)-(19), in which the performing the symmetry geometry reparameterization on the UV reparameterized mesh further comprises: performing symmetry displacement refinement on the UV reparameterized mesh based on the one or more symmetrical properties of the UV reparameterized mesh.

What is claimed is:

1. A method performed by at least one processor of an encoder, the method comprising:
performing, on a mesh, decimation process based on one or more symmetrical properties of the mesh to generate a decimated mesh;
performing UV reparameterization on the decimated mesh to generate a UV reparameterized mesh;
performing a symmetry geometry reparameterization on the UV reparameterized mesh based on one or more symmetrical properties of the of the UV reparameterized mesh to generate geometric information for encoding the mesh; and
encoding the mesh based on the generated geometric information.

2. The method of claim 1, wherein the performing the decimation process further comprises:
performing symmetry estimation on the mesh to estimate a mirror symmetry plane that partitions the mesh into a first side and a second side to generate a partitioned mesh;
performing symmetry extraction on the partitioned mesh to extract the first side of the partitioned mesh;
performing decimation on the first side of the mesh; and
performing symmetry prediction after the decimation is performed to predict the second side of the partitioned mesh to generate the decimated mesh.

3. The method of claim 2, wherein the performing the decimation process further comprises:
performing, after the symmetry prediction is performed, symmetry displacement to compensate for symmetry prediction error generated by the symmetry prediction.

4. The method of claim 1, wherein the performing the symmetry geometry reparameterization on the UV reparameterized mesh further comprises:
performing symmetry base mesh refinement on the UV reparameterized mesh based on the one or more symmetrical properties of the UV reparameterized mesh.

5. The method of claim 4, wherein an output of the symmetry base mesh refinement is provided to a lossless mesh encoder to generate base mesh binary information included in a bitstream.

6. The method of claim 1, wherein the performing the symmetry geometry reparameterization on the UV reparameterized mesh further comprises:
performing symmetry displacement refinement on the UV reparameterized mesh based on the one or more symmetrical properties of the UV reparameterized mesh.

7. The method of claim 6, further comprising:
performing symmetry displacement coding on an output of the symmetry displacement refinement to generate symmetry displacement binary information included in a bitstream.

8. An encoder comprising:
at least one memory configured to store program code; and
at least one processor configured to read the program code and operate as instructed by the program code, the program code comprising:
first decimation code configured to cause the at least one processor to perform, on a mesh, a decimation process based on one or more symmetrical properties of the mesh to generate a decimated mesh,
UV reparameterization code configured to cause the at least one processor to perform UV reparameterization on the decimated mesh to generate a UV reparameterized mesh,
symmetry geometry reparameterization code configured to cause the at least one processor to perform symmetry geometry reparameterization on the UV reparameterized mesh based on one or more symmetrical properties of the of the UV reparameterized mesh to generate geometric information for encoding the mesh, and
encoding code configured to cause the at least one processor to encode the mesh based on the generated geometric information.

9. The encoder of claim 8, wherein the first decimation code further comprises:
symmetry estimation code configured to cause the at least one processor to perform symmetry estimation on the mesh to estimate a mirror symmetry plane that partitions the mesh into a first side and a second side to generate a partitioned mesh,
symmetry extraction code configured to cause the at least one processor to perform symmetry extraction on the partitioned mesh to extract the first side of the partitioned mesh,
second decimation code configured to cause the at least one processor to perform decimation on the first side of the mesh; and
symmetry prediction code configured to cause the at least one processor to perform symmetry prediction after the decimation is performed to predict the second side of the partitioned mesh to generate the decimated mesh.

10. The encoder of claim 9, wherein first decimation code further comprises:
symmetry displacement code configured to cause the at least one processor to perform, after the symmetry prediction is performed, symmetry displacement to compensate for symmetry prediction error generated by the symmetry prediction.

11. The encoder of claim 8, wherein the symmetry geometry reparameterization code further comprises:
symmetry base mesh refinement code configured to cause the at least one processor to perform a symmetry base mesh refinement on the UV reparameterized mesh based on the one or more symmetrical properties of the UV reparameterized mesh.

12. The encoder of claim 11, wherein an output of the symmetry base mesh refinement is provided to a lossless mesh encoder to generate base mesh binary information included in a bitstream.

13. The encoder of claim 8, wherein symmetry geometry reparameterization code further comprises:
symmetry displacement refinement code configured to cause the at least one processor to perform symmetry displacement refinement on the UV reparameterized mesh based on the one or more symmetrical properties of the UV reparameterized mesh.

14. The encoder of claim 13, wherein the program code further comprises:
symmetry displacement code configured to cause the at least one processor to perform a symmetry displacement coding on an output of the symmetry displacement refinement to generate symmetry displacement binary information included in a bitstream.

15. A non-transitory computer readable medium having instructions stored therein, which when executed by a processor in an encoder cause the encoder to execute a method comprising:
performing, on a mesh, decimation process based on one or more symmetrical properties of the mesh to generate a decimated mesh;
performing UV reparameterization on the decimated mesh to generate a UV reparameterized mesh;
performing a symmetry geometry reparameterization on the UV reparameterized mesh based on one or more symmetrical properties of the of the UV reparameterized mesh to generate geometric information for encoding the mesh; and
encoding the mesh based on the generated geometric information.

16. The non-transitory computer readable medium of claim 15, wherein the performing the decimation further comprises:
performing symmetry estimation on the mesh to estimate a mirror symmetry plane that partitions the mesh into a first side and a second side to generate a partitioned mesh;
performing symmetry extraction on the partitioned mesh to extract the first side of the partitioned mesh;
performing decimation on the first side of the mesh; and
performing symmetry prediction after the decimation is performed to predict the second side of the partitioned mesh to generate the decimated mesh.

17. The non-transitory computer readable medium of claim 16, wherein the performing the decimation process further comprises:
performing, after the symmetry prediction is performed, symmetry displacement to compensate for symmetry prediction error generated by the symmetry prediction.

18. The non-transitory computer readable medium of claim 15, wherein the performing the symmetry geometry reparameterization on the UV reparameterized mesh further comprises:
performing symmetry base mesh refinement on the UV reparameterized mesh based on the one or more symmetrical properties of the UV reparameterized mesh.

19. The non-transitory computer readable medium of claim 18, wherein an output of the symmetry base mesh refinement is provided to a lossless mesh encoder to generate base mesh binary information included in a bitstream.

20. The non-transitory computer readable medium of claim 15, wherein the performing the symmetry geometry reparameterization on the UV reparameterized mesh further comprises:
performing symmetry displacement refinement on the UV reparameterized mesh based on the one or more symmetrical properties of the UV reparameterized mesh.
